(19) United States
(12) Patent Application Publication
(10) Pub. No.: US 2024/0388986 A1
(43) Pub. Date: Nov. 21, 2024

(54) COMMUNICATION SYSTEM, COMMUNICATION METHOD, COMMUNICATION DEVICE, COMMUNICATION PROGRAM

(71) Applicant: NIPPON TELEGRAPH AND TELEPHONE CORPORATION, Tokyo (JP)

(72) Inventors: Hiroya ONO, Musashino-shi, Tokyo (JP); Yuki SAKAUE, Musashino-shi, Tokyo (JP); Takuya ABE, Musashino-shi, Tokyo (JP); Satoshi NARIKAWA, Musashino-shi, Tokyo (JP)

(73) Assignee: NIPPON TELEGRAPH AND TELEPHONE CORPORATION, Tokyo (JP)

(21) Appl. No.: 18/688,994

(22) PCT Filed: Sep. 13, 2021
(86) PCT No.: PCT/JP2021/033459

§ 371 Date: Mar. 4, 2024

(51) Int. Cl. H04W 36/30; H04W 36/00; H04W 36/14

(52) U.S. Cl. CPC H04W 36/304; H04W 36/0055; H04W 36/14

(57) ABSTRACT

An object of the present disclosure is to prevent a decrease in a window size, thereby reducing a quality degradation time due to handover processing.

The present disclosure is a communication system in which a communication terminal communicates with an arbitrary communication device according to an allocated window size, in which the communication system saves a window size before handover or a window size determined based on the window size when the communication terminal performs the handover, and determines window size after the handover based on the saved window size.

### TECHNICAL FIELD

The present disclosure relates to a communication system in which a communication terminal communicates with an arbitrary communication device according to an allocated window size.

### BACKGROUND ART

In recent years, a plurality of communication networks (hereinafter, may be referred to NW) have been able to be used for a communication terminal. Using a NW with high quality from a plurality of NWs, the quality of experience of the user is improved. Actually, it is possible to perform handover aiming at a NW which is considered to be improved in quality from information such as received radio wave intensity of the IEEE 802.11 wireless LAN [see, for example, Non Patent Literature 1].

However, when handover processing to the NW which is considered to improve the quality is performed, establishment of a new TCP session or session re-establishment of an application layer is performed, and temporary communication interruption occurs until the establishment is completed. As a result, even if the handover to the NW that is supposed to obtain high quality is attempted, the communication quality is deteriorated for a while from the start of switching.

In order to prevent such session disconnection, there is Mobile IPV6 as a technology that performs encapsulation processing as if the IP address of the communication terminal were unchanged and does not require a new TCP session and session re-establishment at the application layer [see Non Patent Literature 2]. However, even when the Mobile IPV6 is used, disconnection, connection, and IP address related processing in a low-layer protocol are performed at the time of handover, and thus, a communication unavailable time temporarily occurs. Even in a state where the session of the upper protocol is continued, when this communication unavailable time occurs, the upper protocol may recognize that packet loss has occurred.

In the TCP protocol, when packet loss is detected, a window size is reduced. Therefore, a TCP throughput is reduced, and a time lag occurs until the throughput returns to a conventional throughput. Therefore, in a combination of a technique of hiding an existing IP address change and a general TCP protocol, it is not possible to immediately enjoy high quality communication in the NW of the handover destination.

### CITATION LIST

### Non Patent Literature

Non Patent Literature 1: Keisuke Wakao, Kenichi Kawamura, Takatsune Moriyama, “Quality Prediction Technology for Optimal Use of Multiple Wireless Access Networks”, NTT Technical Journal, April 2020, p. 11-13 https://journal.ntt.co.jp/wp-content/uploads/2020/05/JN20200411.pdf

Non Patent Literature 2: IETF RFC2002 “IP mobility support” https://datatracker.ietf.org/doc/html/rfc2002

### SUMMARY OF INVENTION

### Technical Problem

An object of the present disclosure is to reduce quality degradation time caused by handover processing.

### Solution to Problem

A communication system of the present disclosure is a communication system in which a communication terminal communicates with an arbitrary communication device according to an allocated window size, in which the communication system saves a window size before handover or a window size determined based on the window size when the communication terminal performs the handover, and determines window size after the handover based on the saved window size.

A communication method of the present disclosure is a method executed by a system in which a communication terminal communicates with an arbitrary communication device according to an allocated window size, the system including
saving a window size before handover or a window size determined based on the window size when the communication terminal performs handover, and
determining a window size after handover based on the saved window size.

A communication device of the present disclosure functions as a communication terminal or a communication device included in the communication system of the present disclosure.

### Advantageous Effects of Invention

According to the present disclosure, since the window size after the handover is determined based on the window size before the handover, the window size can be instantaneously recovered. Therefore, the present disclosure can reduce the quality degradation time due to the handover processing.

### BRIEF DESCRIPTION OF DRAWINGS

FIG. 1 illustrates an outline of a system according to the present embodiment.

FIG. 2 illustrates an example of a TCP window size when temporary communication interruption occurs.

FIG. 3 illustrates an example of a TCP window size according to the present disclosure.

FIG. 4 is a functional block diagram for realizing the present disclosure by downstream communication.

FIG. 5 is a functional block diagram for realizing the present disclosure by upstream communication.

FIG. 6 is a flowchart of terminal operation during downstream communication.

FIG. 7 is a flowchart illustrating operations of the communication terminal and a communication destination server during upstream communication.

### DESCRIPTION OF EMBODIMENTS

Hereinafter, embodiments of the present disclosure will be described in detail with reference to the drawings. Note that the present disclosure is not limited to the embodiments described below. These embodiments are merely examples, and the present disclosure can be carried out in forms with various modifications and improvements based on the knowledge of those skilled in the art. Note that components having the same reference numerals in the present specification and the drawings denote the same components.

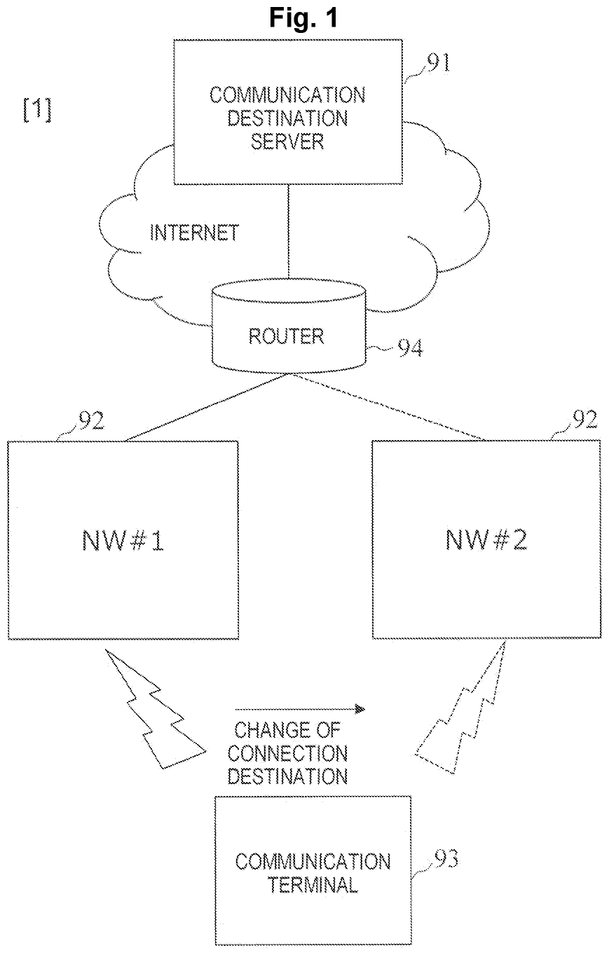

FIG. 1 illustrates a configuration example of a system according to the present embodiment. In the communication system according to the present embodiment, a communication terminal 93 communicates with a communication destination server 91. The communication terminal 93 is a wireless communication terminal capable of communication, and communicates with the communication destination server 91 according to the allocated window size. The communication destination server 91 is any communication device capable of communicating with the communication terminal 93 according to the allocated window size.

The communication destination server 91 and the communication terminal 93 function as the communication device of the present disclosure. The communication device according to the present disclosure can also be implemented by a computer and a program, and the program can be provided by being recorded in a recording medium or via a network. A program of the present disclosure is a program for causing a computer to be implemented as each functional unit included in the device according to the present disclosure, and is a program for causing a computer to perform each step included in the method to be performed by the device according to the present disclosure.

The present embodiment illustrates an example in which the communication destination server 91 is connected to NWs 92 #1 and 92 #2 through a network device such as a router 94, and the communication terminal 93 performs handover from the NW 92 #1 to the NW 92 #2.

In a case where the communication terminal 93 hands over from the NW 92 #1 to the NW 92 #1,

S1: disconnection is performed at a data link layer (L2) with the NW 92 #1,

S2: connection processing is performed with the NW 92 #2 at the L2,

S3: IP address in the NW 92 #2 is assigned to communication terminal 93,

S4: a TCP session between the communication destination server 91 and the communication terminal 93 is established by the NW 92 #2, and

S5: a session at an application layer between the communication destination server 91 and the communication terminal 93 is re-established.

In this way, when the handover processing from the NW 92 #1 to the NW 92 #2 is performed, establishment of a new TCP session and session re-establishment of the application layer are performed, and temporary communication interruption occurs until the establishment is completed. As a result, even if the handover to the NW that is supposed to obtain high quality is attempted, the communication quality is deteriorated for a while from the start of switching.

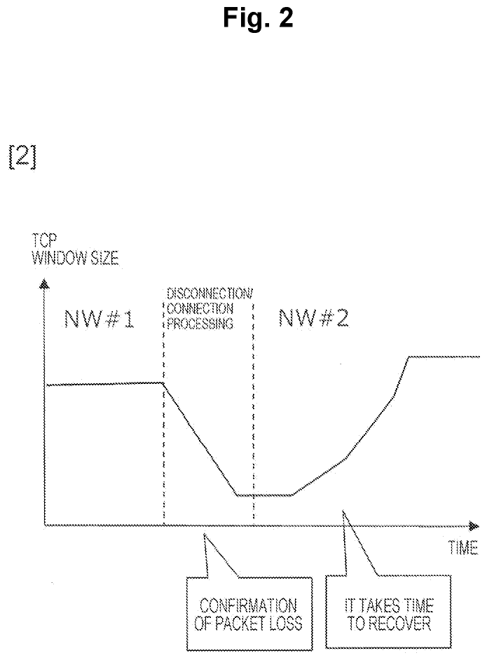

FIG. 2 illustrates an example of a TCP window size when temporary communication interruption occurs. However, disconnection, connection, and IP address related processing in a low-layer protocol are performed at the time of handover, and thus, a communication unavailable time temporarily occurs. In a state where the session of the upper protocol is continued, when this communication unavailable time occurs, the upper protocol may recognize that packet loss has occurred. In the TCP protocol, a TCP throughput is reduced because a TCP window size is reduced when packet loss is detected. Therefore, it is not possible to immediately enjoy high-quality communication in the NW #2 of the handover destination.

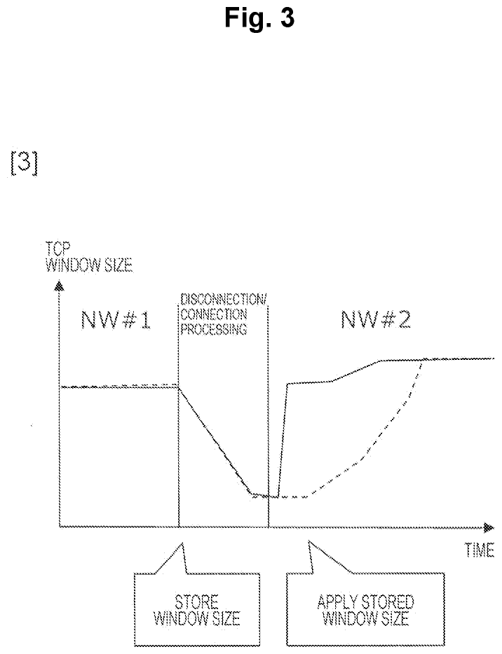

Therefore, in the present disclosure, as illustrated in FIG. 3, when the NW handover occurs, the previous TCP window size is stored at the start of the processing, and is called at the end of the handover. As a result, the TCP window size after the handover is recovered promptly, and a high TCP throughput is obtained in a short time after switching. Therefore, the present disclosure reduces the quality degradation time in the NW handover, and enables active connection destination switching to the NW expected to have high quality. The storage of the TCP window size may be the communication terminal 93, the communication destination server 91, or a network device such as a proxy server. This will be described below in more detail.

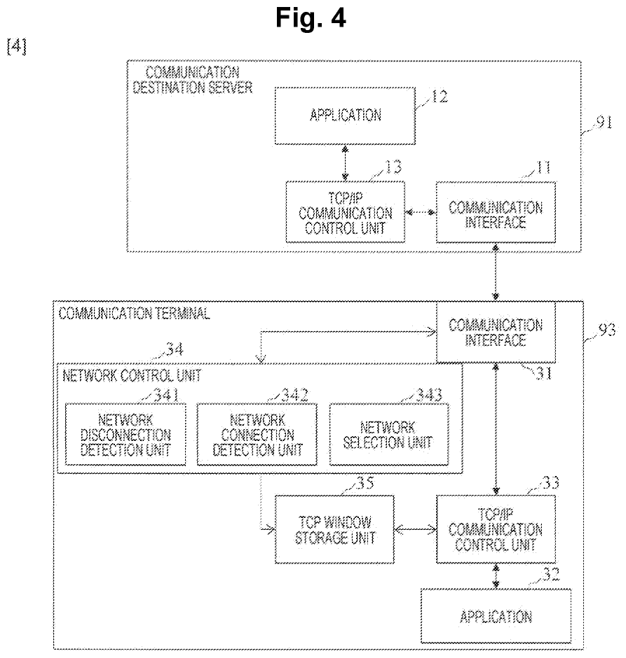

FIG. 4 is a functional block diagram for realizing the present disclosure by downstream communication. The communication destination server 91 includes a communication interface 11, an application 12, and a TCP/IP communication control unit 13. The communication terminal 93 includes a communication interface 31, an application 32, a TCP/IP communication control unit 33, a network control unit 34, and a TCP window storage unit 35. The network control unit 34 includes a network disconnection detection unit 341, a network connection detection unit 342, and a network selection unit 343.

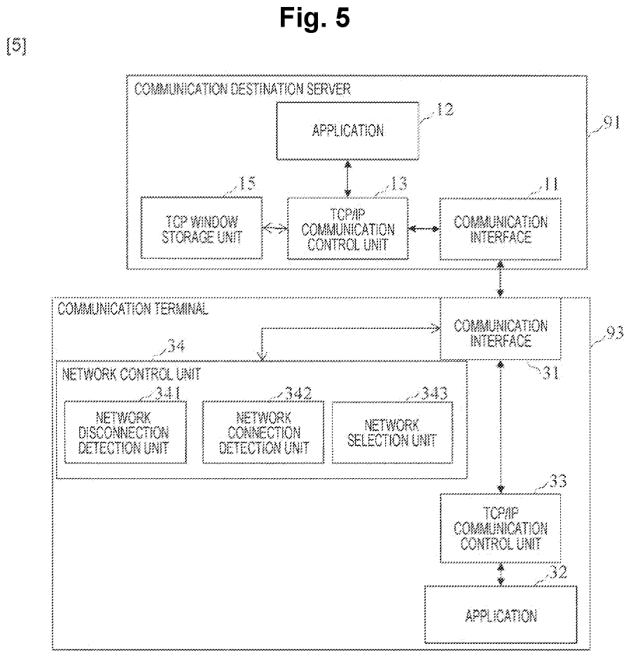

FIG. 5 is a functional block diagram for realizing the present disclosure by upstream communication. The communication destination server 91 includes the communication interface 11, the application 12, the TCP/IP communication control unit 13, and the TCP window storage unit 15. The communication terminal 93 includes the communication interface 31, the application 32, the TCP/IP communication control unit 33, and the network control unit 34. The network control unit 34 includes a network disconnection detection unit 341, a network connection detection unit 342, and a network selection unit 343.

The application 32 is an application used by the communication terminal 93. The application 12 has a function included in the communication destination server 91 that can execute the application 32.

The communication interfaces 11 and 31 are all interfaces capable of TCP/IP communication, such as IEEE 802.3, IEEE 802.11, and 3GPP 5G NR.

The TCP/IP communication control units 13 and 33 are functional units that control a general TCP/IP protocol. For the receiving side, the unit notifies the transmission source of the TCP window size.

The network disconnection detection unit 341 is a functional unit that detects network disconnection and provides a trigger for storing a TCP window size.

The network connection detection unit 342 is a functional unit that detects completion of network connection and gives a stored trigger for applying the TCP window.

The network selection unit 343 is a functional unit that estimates and selects an NW capable of performing high-quality communication as compared with the immediately preceding connection NW. The method of estimating and selecting the NW is arbitrary and is not defined in the present disclosure.

In the upstream communication, as illustrated in FIG. 4, the communication terminal 93 includes the TCP window storage unit 35. On the other hand, in the upstream communication, as illustrated in FIG. 5, the communication destination server 91 includes the TCP window storage unit 15. The TCP window storage unit 35 is a functional unit that saves a previous TCP window size and sets parameters in the TCP/IP communication control unit 33 in response to an external trigger. The TCP window storage unit 15 is a functional unit that saves a previous TCP window size and sets parameters in the TCP/IP communication control unit 13 in response to an external trigger.

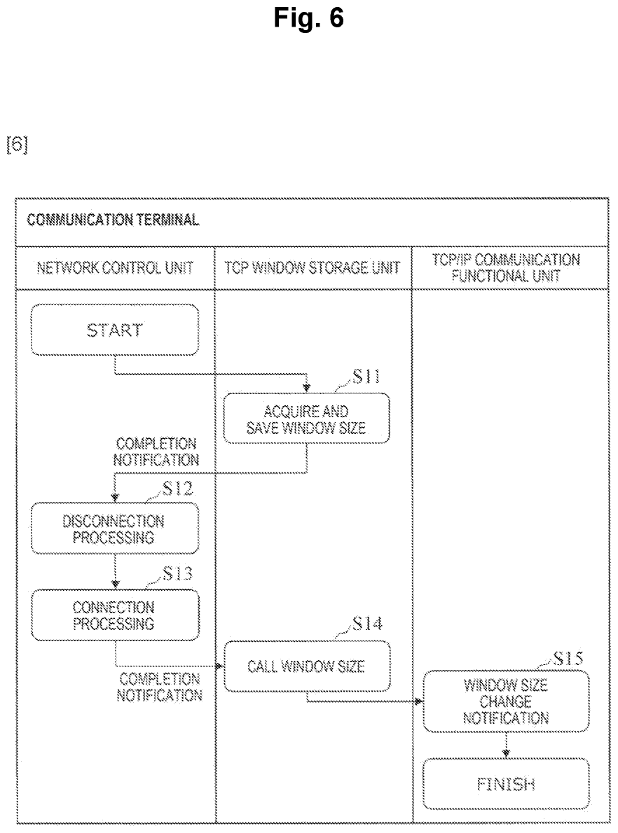

FIG. 6 is a flowchart of the operation of the communication terminal 93 during the downstream communication. Based on a certain NW selection algorithm, the network control unit 34 determines whether it is possible to perform higher-quality communication by switching to a different NW than the already connected NW. For example, there is a method of Non Patent Literature 1. In a case of performing the NW switching, the TCP window storage unit 35 is notified of the TCP window size at that time, and the TCP window storage unit 35 stores the TCP window size (S11).

The TCP/IP communication control unit 33 performs disconnection processing from the NW #1 (S12), and performs connection processing with the NW #2 (S13). When the connection processing (IP address-related setting) of the switching destination NW is completed (S13), the network control unit 34 instructs the TCP window storage unit 35 to call the TCP window size (S14). The TCP window storage unit 35 notifies the TCP/IP communication control unit 33 of the called value of the TCP window size before switching (S15), and the TCP/IP communication control unit 33 that has received the value notifies the TCP/IP communication control unit 13 of the communication destination server 91 of the update of the TCP window size.

Thereafter, general TCP/IP communication is performed.

As described above, in the downstream communication from the communication destination server 91, the amount of data (TCP window size) that can be transmitted before returning ack can be instantaneously recovered, and a high TCP throughput can be realized immediately after switching.

Note that the notification of the TCP window size in step S11 may be after step S12. For example, the notification of the TCP window size may be performed using the completion of the disconnection processing of the connected NW as a trigger.

In addition, the window size after the handover is not limited to the window size immediately before the handover, and may be a window size determined on the basis of the window size before the handover. For example, it may be the maximum window size within a certain period of time before the handover. In addition, in a case where the expected quality after the NW switching can be predicted in detail by the algorithm of an NW selection unit 343, a value higher than the window size before the switching may be stored.

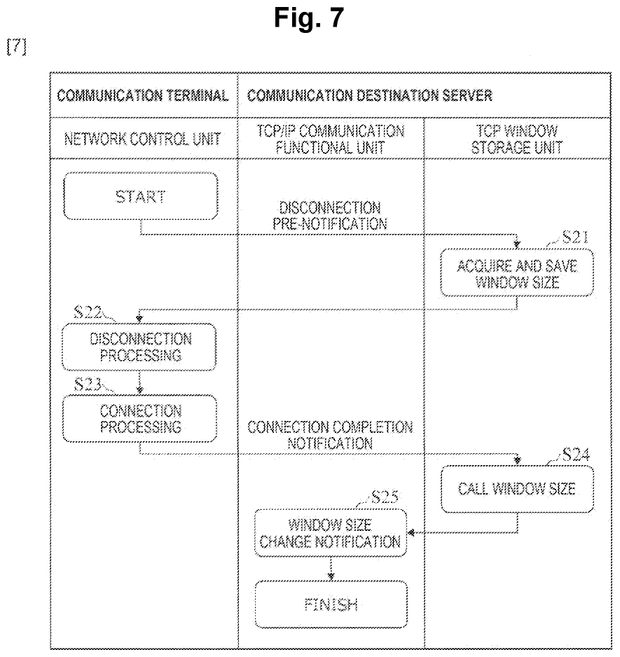

FIG. 7 is a flowchart illustrating operations of the communication terminal 93 and the communication destination server 91 during upstream communication. Based on a certain NW selection algorithm, the network control unit 34 of the communication terminal 93 determines whether it is possible to perform higher-quality communication by switching to a different NW 92 #1 than the already connected NW.

In a case of performing the NW switching, the network control unit 34 of the communication terminal 93 performs a disconnection pre-notification to the communication destination server 91. The disconnection pre-notification is a notification of pre-notification that disconnection of the communication network occurs, and includes information on the TCP window size at that time. When receiving the disconnection notice, the communication destination server 91 saves the received TCP window size in the TCP window storage unit 15 (S21).

Note that the saving of the TCP window size in step S21 may be a format in which the communication destination server 91 autonomously saves the previous TCP window size or the maximum TCP window size within a certain period when the data packet from the communication terminal 93 does not arrive for a certain period of time.

The TCP/IP communication control unit 33 performs processing of disconnecting from the NW #1 (S22) and performs processing of connecting to the NW #2 (S23). When the communication terminal 93 has completed the connection processing (IP address-related setting) to the switching destination NW 92 #2, the communication terminal 93 notifies the communication destination server 91 of the connection completion.

Here, in a case where the IP address continuation function such as Mobile IPV6 is provided in the communication terminal 93 and the NW, since the past TCP session is continued, the communication confirmation is performed based on the transmission data from the communication terminal 93. In a case where the IP address continuation function is not provided, notification of a temporary terminal ID is also provided at the time of the disconnection pre-notification, and the terminal ID is retransmitted after newly establishing a TCP session with the communication destination server 91, thereby recognizing that the notification is from the same communication terminal 93.

The TCP/IP communication control unit 13 of the communication destination server 91 acquires the TCP window size stored in the TCP window storage unit 15. The TCP/IP communication control unit 13 of the communication destination server 91 notifies the TCP/IP communication control unit 33 of the communication terminal 93 of the update of the TCP window size to update the acquired TCP window size.

Thereafter, general TCP/IP communication is performed.

As described above, in the upstream communication from the communication terminal 93, the amount of data (TCP window size) that can be transmitted before returning ack is instantaneously recovered, and a high TCP throughput is realized immediately after switching.

As an application destination of the present disclosure, by combining with a system in which the quality of the NW after switching can be predicted in advance as in Non Patent Literature 1, it can be expected that the high quality of the NW after switching is converted to the improvement of the sensible quality. In this combination, it is not necessary to confirm the quality by flowing the traffic to the NW to be switched in advance or to increase the TCP window size, and thus, it is possible to perform NW control with the terminal load and the NW load minimized.

### INDUSTRIAL APPLICABILITY

The present disclosure can be applied to the information and communications industry.

### REFERENCE SIGNS LIST

11, 31 Communication interface

12, 32 Application

13, 33 TCP/IP communication control unit

15, 35 TCP window storage unit

34 Network control unit

341 Network disconnection detection unit

342 Network connection detection unit

343 Network selection unit

91 Communication destination server

92 Communication network

93 Communication terminal

94 Router

1. A communication system in which a communication terminal communicates with an arbitrary communication device according to an allocated window size, wherein the communication system saves a window size before handover or a window size determined based on the window size when the communication terminal performs the handover, and
determines window size after the handover based on the saved window size.

2. The communication system according to claim 1, wherein the communication terminal
saves a window size before the handover or a window size determined based on the window size, and
notifies the communication device of a saved window size after the handover, and
the communication device establishes a connection with the communication terminal using the window size notification of which is provided from the communication terminal.

3. The communication system according to claim 1, wherein
the communication terminal gives a disconnection notice to the communication device before the handover, and
the communication device saves the window size before the handover when receiving the disconnection notice, and
after the handover, the communication device establishes a connection with the communication terminal using the saved window size.

4. The communication system according to claim 1, wherein
the communication device
saves a window size for establishing a connection with the communication terminal for a predetermined time after the connection with the communication terminal is disconnected, and
when the connection with the communication terminal is resumed at the predetermined time, establishes the connection with the communication terminal using the saved window size.

5. A communication device that functions as a communication terminal that communicates with an arbitrary communication device according to an allocated window size, wherein the communication device
saves a window size before handover or a window size determined based on the window size when the handover is performed,
after the handover, notifies the communication device of the saved window size, and
uses a window size before the handover to establish a connection with the communication device.

6. (canceled)

7. A non-transitory computer-readable medium having computer-executable instructions that, upon execution of the instructions by a processor of a computer, cause the computer to function as the communication device according to claim 5.

8. A communication method executed by a system in which a communication terminal communicates with an arbitrary communication device according to an allocated window size, the method comprising:
saving a window size before handover or a window size determined based on the window size when the communication terminal performs the handover; and
determining a window size after the handover based on the saved window size.
